(19) United States
(12) Patent Application Publication
(10) Pub. No.: US 2013/0197707 A1
(43) Pub. Date: Aug. 1, 2013

(54) Apparatus and method for harvesting and storing energy

(71) Applicants: Joel P. Keily, Corona, CA (US); Lockland Everard Corley, Coquitlam (CA); Charles Parkin Davis, Torrance, CA (US); Richard Ybo Lalau, North Vancouver (CA); Yuval Uriel, Mission (CA)

(72) Inventors: Joel P. Keily, Corona, CA (US); Lockland Everard Corley, Coquitlam (CA); Charles Parkin Davis, Torrance, CA (US); Richard Ybo Lalau, North Vancouver (CA); Yuval Uriel, Mission (CA)

(73) Assignee: DISPENSING DYNAMICS INTERNATIONAL

(21) Appl. No.: 13/507,352

(22) Filed: Jun. 21, 2012

Related U.S. Application Data
(60) Provisional application No. 61/571,240, filed on Jun. 23, 2011.
(60) Provisional application No. 61/575,588, filed on Aug. 24, 2011.

(51) Int. Cl. G06F 1/26

(52) U.S. Cl. 700/295

(57) ABSTRACT

A system for harvesting and storing energy including photovoltaic structure continuously harvesting energy from an internal lighting system, at least one supercapacitor for receiving and storing electrical energy produced by the photovoltaic structure, and a microprocessor continually powered by the supercapacitor and programmed to activate an electrically operated device when the stored energy in the supercapacitor exceeds a minimum voltage charge level sufficient to maintain operation of the microprocessor.

This application is based on and claims the benefit of U.S. Provisional Patent Application No. 61/571,240, filed Jun. 23, 2011 and U.S. Provisional Patent Application No. 61/575,588, filed Aug. 24, 2011.

This application includes a computer program listing Appendix in the form of a compact disc (two identical copies). The files of the compact disc are specified in an Attachment located at the end of the specification and before the claims hereof.

### TECHNICAL FIELD

This invention relates to a system for harvesting and storing energy, more particularly to solar powered apparatus and a method employed as an electrical power source for an electrically operated device.

### BACKGROUND OF THE INVENTION

It is of course known to utilize solar panels to power many types of equipment and devices. Conventionally, such arrangements also utilize external power sources or internal batteries to assure a power source for load requirements.

### DISCLOSURE OF INVENTION

The apparatus and the method of the present invention are utilized to harvest energy from a single or a series of indoor solar panels designed to continually harvest and store energy within a single or series of supercapacitors. The stored harvested energy serves as a stand-alone power source that powers a microprocessor while managing other load requirements making the need for external power sources or internal batteries obsolete. The invention uniquely is applicable for indoor use, collecting and harvesting energy from an internal lighting system.

The apparatus of the present invention is for harvesting and storing energy, the apparatus employed as an electrical power source for an electrically operated device.

The apparatus includes a photovoltaic structure continuously harvesting energy from an internal lighting system and at least one supercapacitor for receiving and storing electrical energy produced by the photovoltaic structure.

The apparatus includes a microprocessor operatively associated with the at least one supercapacitor and with the electrically operated device. The microprocessor is continually powered by the at least one supercapacitor and programmed to activate or allow activation of the electrically operated device only when the stored energy in the at least one supercapacitor exceeds a minimum voltage charge level sufficient to maintain operation of the microprocessor.

The microprocessor is programmed to manage the voltage charge level of the at least one supercapacitor so that it has or exceeds a minimum voltage charge level sufficient to operate the microprocessor and does not exceed a predetermined maximum voltage charge level.

The method of the invention includes the step of continuously harvesting energy from an internal lighting system utilizing a photovoltaic structure.

At least one supercapacitor is employed to receive and store electrical energy produced by the photovoltaic structure.

A microprocessor is placed in operative association with the at least one supercapacitor and with the electrically operated device. The at least one supercapacitor is utilized to continually power the microprocessor.

The microprocessor is employed to activate or allow activation of the electrically operated device from the stored energy in the at least one supercapacitor only when the stored energy exceeds a minimum voltage charge level sufficient to maintain operation of the microprocessor.

The microprocessor is employed to manage the voltage charge level of the at least one supercapacitor so that it has or exceeds a minimum voltage charge level sufficient to operate the microprocessor and does not exceed a predetermined maximum voltage charge level.

Other features, advantages and objects of the present invention will become apparent with reference to the following description and accompanying drawings.

### BRIEF DESCRIPTION OF DRAWINGS

FIG. 1 is a front, top, perspective view illustrating a scent or air freshener dispenser incorporating the present invention;

FIG. 2 is a rear, bottom perspective view of the dispenser;

FIG. 3 is a cross-sectional view of the dispenser taken along line 3-3 of FIG. 1 and illustrating certain structural components of the dispenser and a cartridge and scent or air freshener element employed therewith;

FIG. 4 is an exploded, perspective view illustrating the structural components of the dispenser and the cartridge and scent or air freshener element employed therewith;

FIG. 5 is a block diagram illustrating a charge management feature of the invention operable to control functions and perpetually harvest energy;

FIG. 6 is a functional source diagram illustrating the operative relationships and functioning of photovoltaic panels, supercapacitors, a microprocessor with embedded software and a motor load resulting in a perpetual and constantly energy replenishing cycle, the photovoltaic panels never being switched off;

FIG. 7 is a reverse current diagram illustrating the features of the invention preventing the harvested energy from leaking or the reverse charging of the photovoltaic panels to optimize the harvested current received and stored by the supercapacitors;

FIG. 8 is a flow diagram illustrating the embedded control logic functions carried out by the apparatus and method of the invention;

FIG. 9 is a flow diagram illustrating sequential functions pertaining to sensing of product placement in a dispenser; and

FIG. 10 is a schematic illustrating electrical circuitry components employed in the apparatus.

### BEST MODE FOR CARRYING OUT THE INVENTION

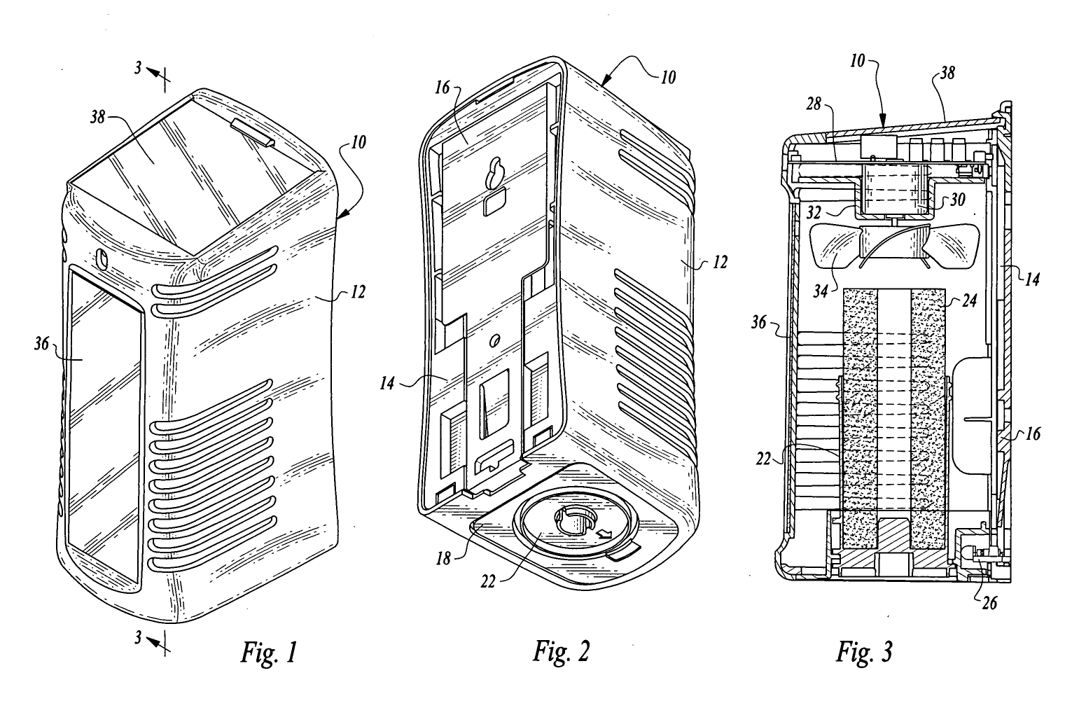

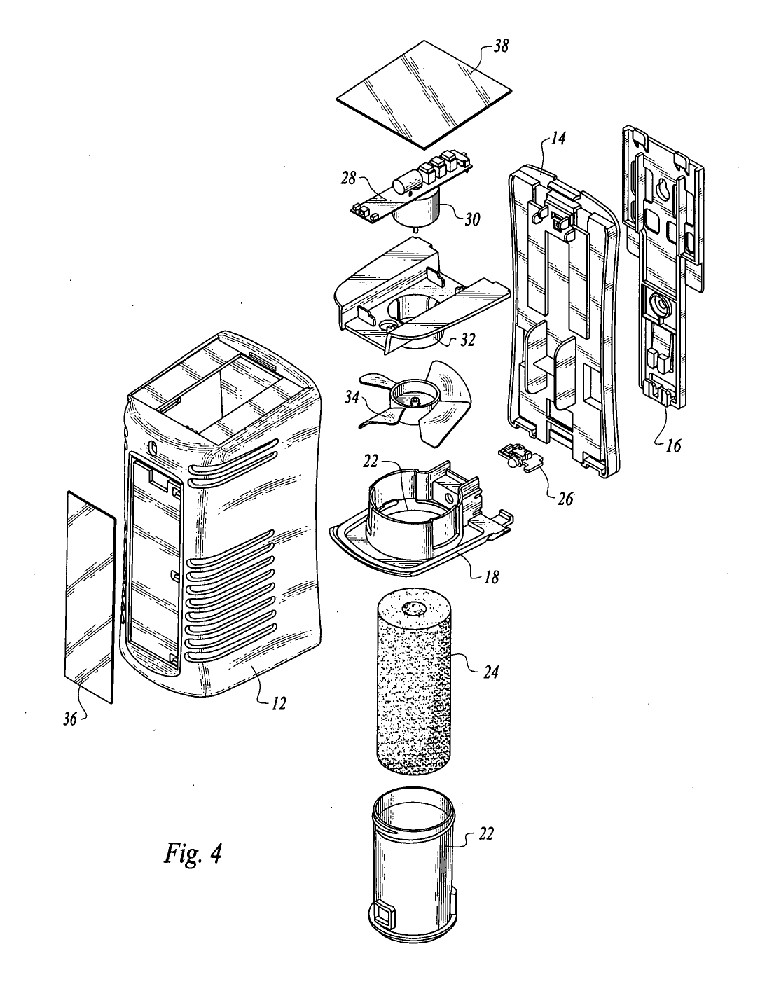

FIGS. 1-4 illustrate a scent or air freshener 10 which utilizes the features of the apparatus and method of the present invention. The dispenser 10 includes a front cover 12 and a rear panel 14 having a mounting bracket 16.

A bottom plate 18 is employed, the bottom plate defining an opening 20 which receives a holder or cartridge 22 holding a scent or air freshener element 24. The holder and bottom plate are releasably connected together to selectively either maintain the air freshener component 24 within the interior of the assembled dispenser housing or allow removal of the holder.

A detection switch 26 is employed to indicate when the holder is in position. This detection switch is operatively associated with control circuitry including a programmed microprocessor which is incorporated in printed circuit board 28.

An electric motor 30 is positioned in a motor housing 32. The motor is selectively activated to rotate a fan blade 34 to dispense scent or air freshener through openings provided in cover 12. The motor is an electrically operated device receiving energy harvested and stored by the apparatus and method of the present invention in a manner described in detail below.

The dispenser 10 includes two photovoltaic solar panels 36, 38 which continuously harvest energy from an internal lighting system and which are operatively associated with at least one supercapacitor which receives and stores the electrical energy.

As will be described in greater detail below, a microprocessor is operatively associated with the at least one supercapacitor and with the electrically operated device, i.e. motor, as well as other electrically operated features and devices incorporated in the dispenser.

Control software of the microprocessor is programmed to activate or allow activation of the motor and possibly selected other operating components of the dispenser only when the stored energy in the at least one supercapacitor exceeds a minimum voltage charge level sufficient to maintain operation of the microprocessor.

The microprocessor is programmed to manage the voltage charge level of the at least one supercapacitor so that it has or exceeds a minimum voltage charge level sufficient to operate the microprocessor and does not exceed a predetermined maximum voltage charge level.

The apparatus and method of the present invention are applicable for use with devices and apparatus other than a scent or air freshener dispenser, the arrangement of FIGS. 1-4 and otherwise disclosed herein merely being representative of a suitable application of the principles of the invention.

The present invention harvests energy from a single or series of indoor solar panels designed to continually harvest and store energy within a single or series of supercapacitors. The stored harvested energy serves as a stand-alone power source that powers a microprocessor while managing other load requirements making the need for external power sources or internal batteries obsolete.

FIG. 6 is a simplified block diagram disclosing the basic elements of the invention. These include a photovoltaic panel or panels for receiving and continuously harvesting energy from an internal lighting system and a supercapacitor or series of supercapacitors for receiving and storing electrical energy produced by the photovoltaic panels. A microprocessor incorporates embedded software and is operatively associated with the at least one supercapacitor and an electrically operated device (a motor in FIG. 6) and is programmed to activate or allow activation of the electrically operated device only when the stored energy in the at least one supercapacitor exceeds a minimum voltage charge level sufficient to maintain operation of the microprocessor.

The microprocessor is continually powered by the supercapacitor and programmed to manage the voltage charge level of the at least one supercapacitor so that it has or exceeds a minimum voltage charge level sufficient to operate of the microprocessor and does not exceed a predetermined maximum voltage charge level. The system does not require any additional internal battery, external battery or outside power sources (AC or DC) and functions entirely from harvested energy.

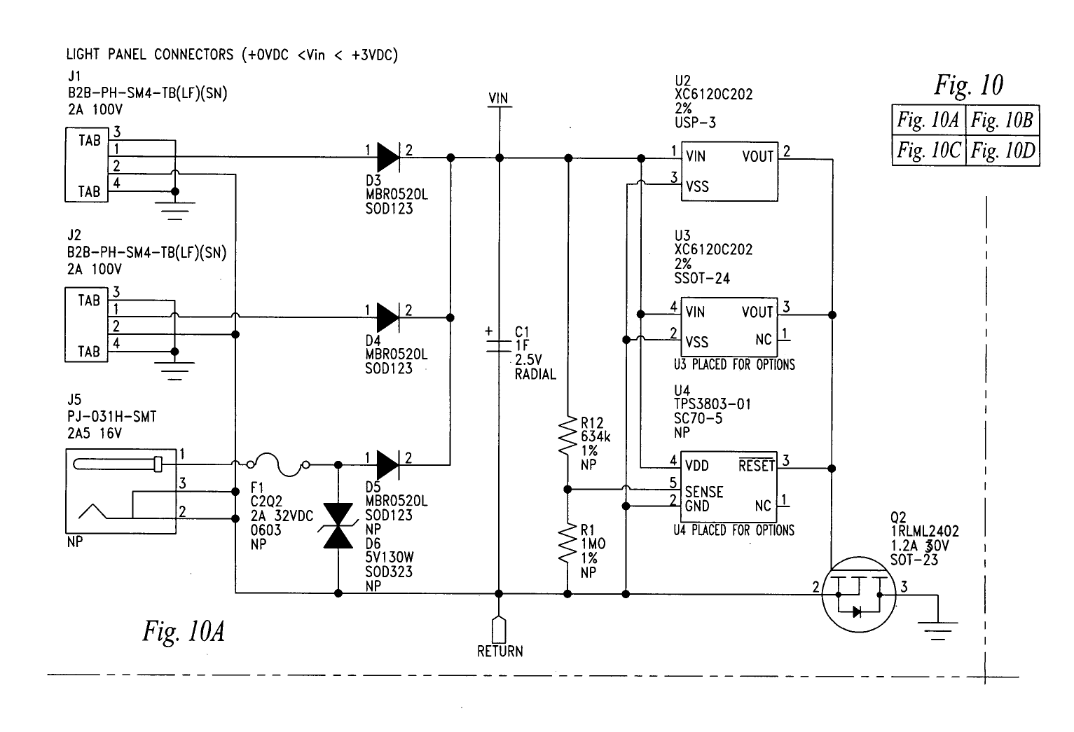

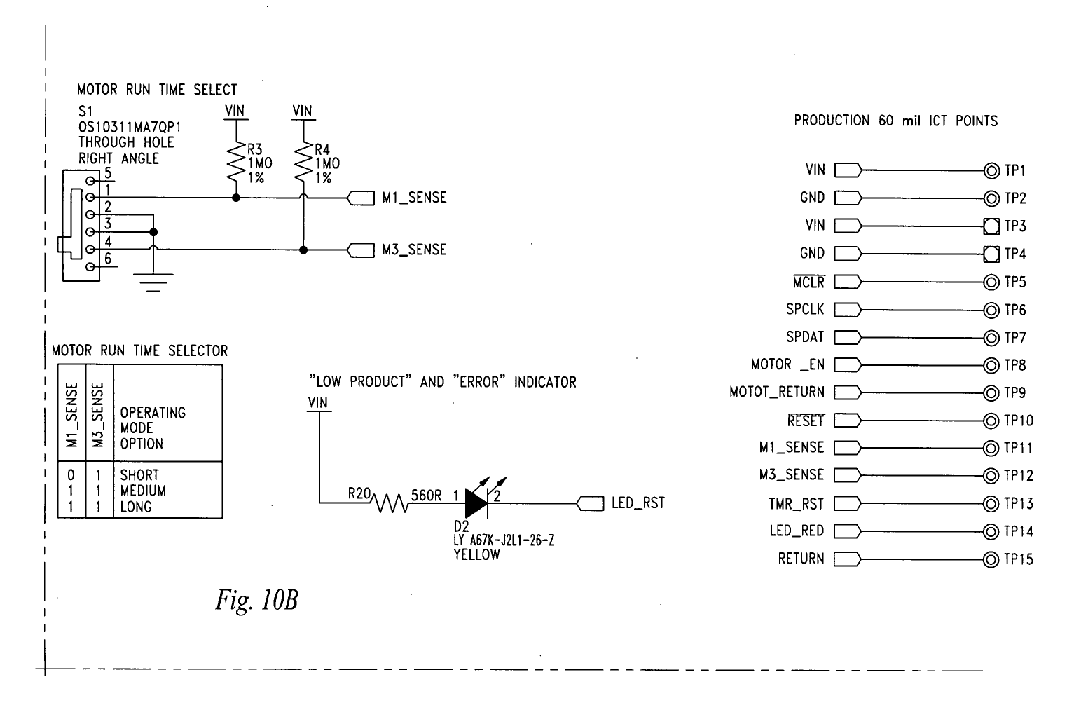

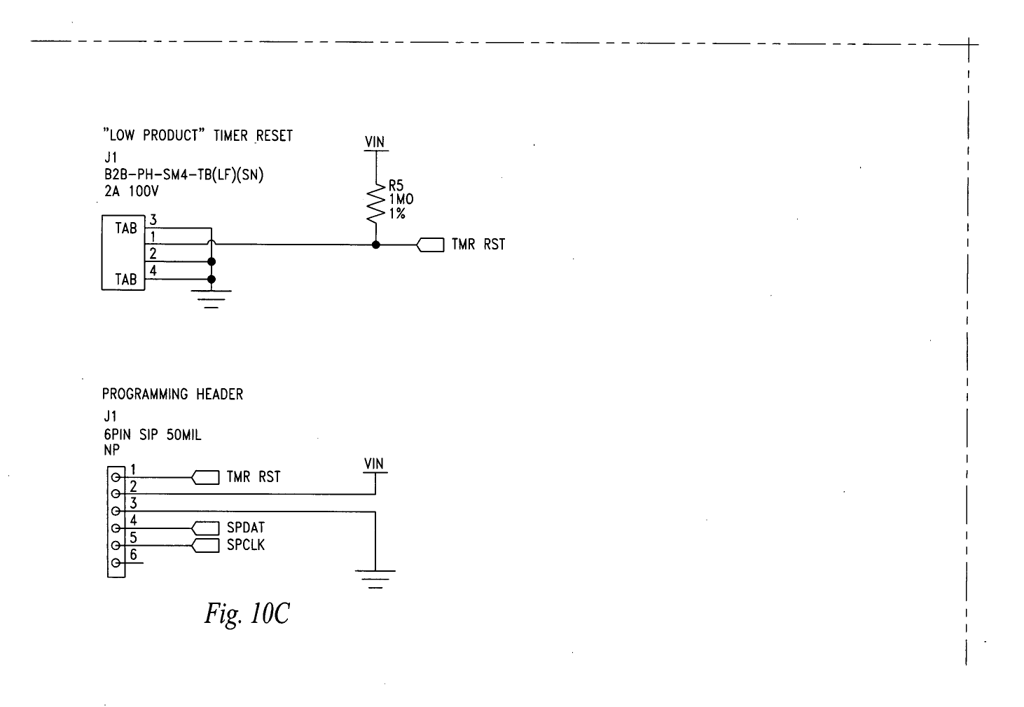

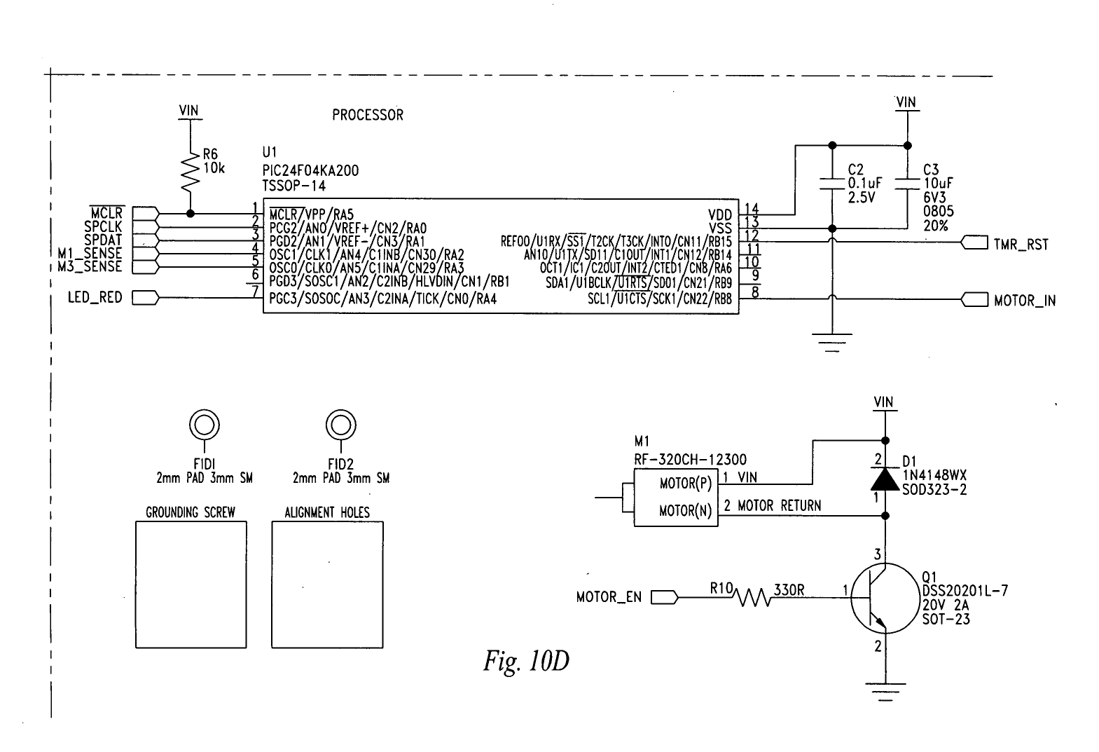

FIG. 10 discloses the microprocessor incorporated in electrical circuitry operatively associated with the at least one supercapacitor. The electronic components of the circuit utilize a microprocessor with embedded software to control operation of the motor and also other features.

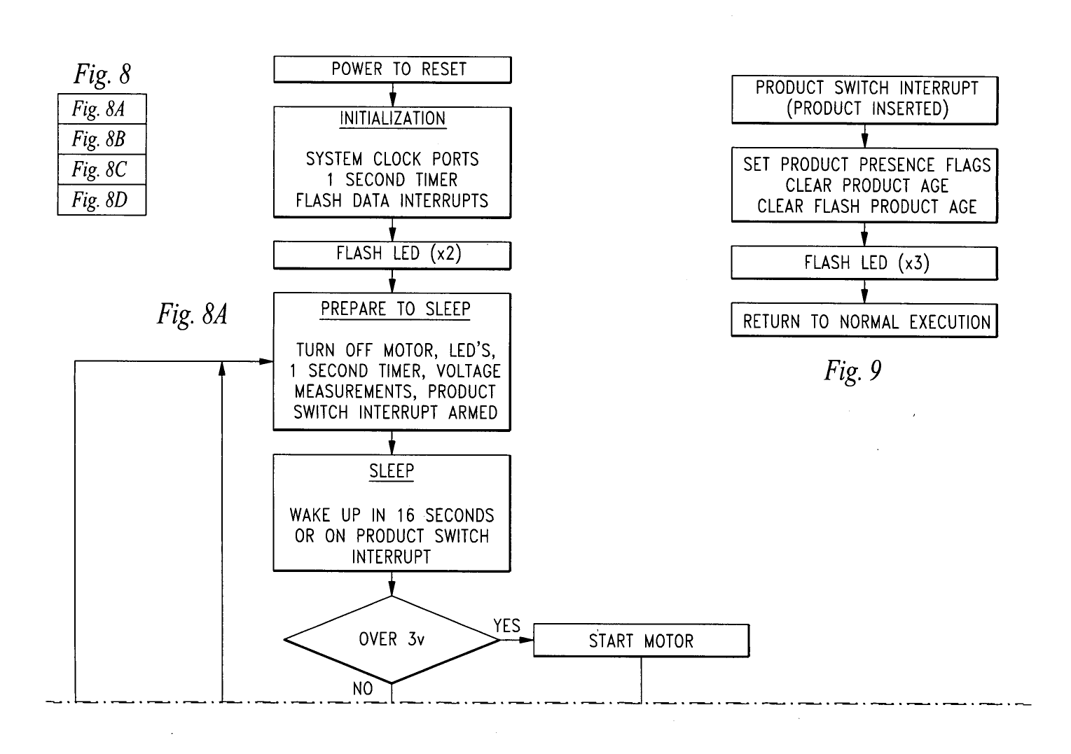

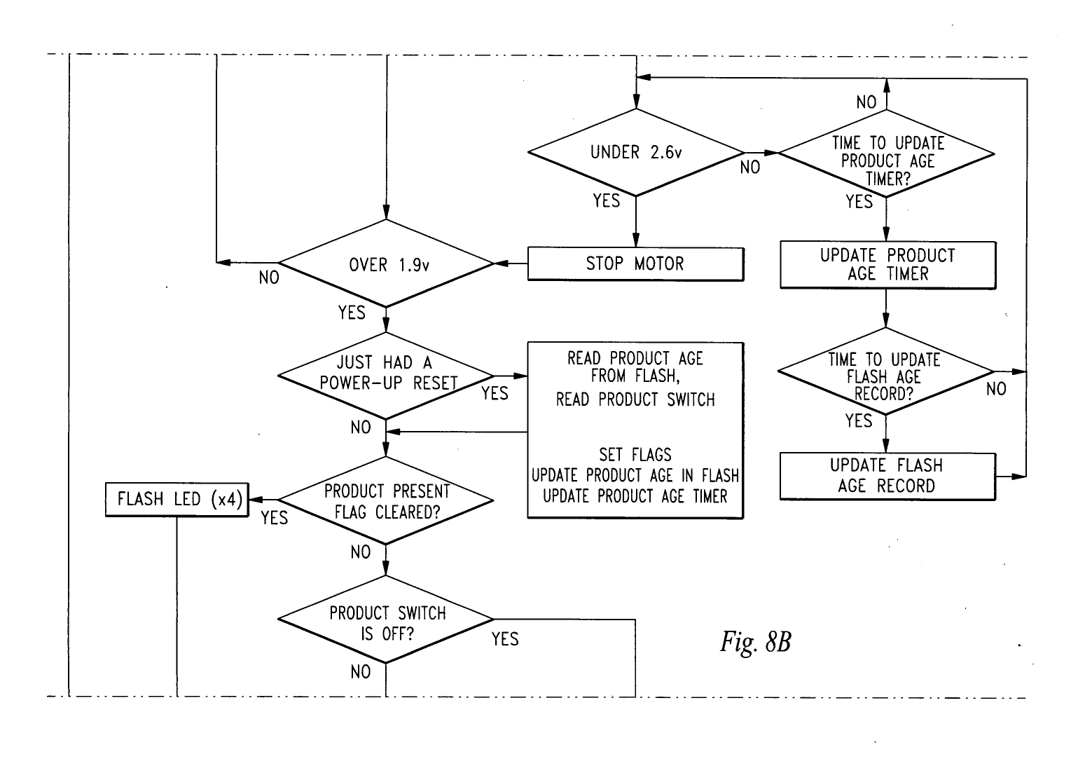

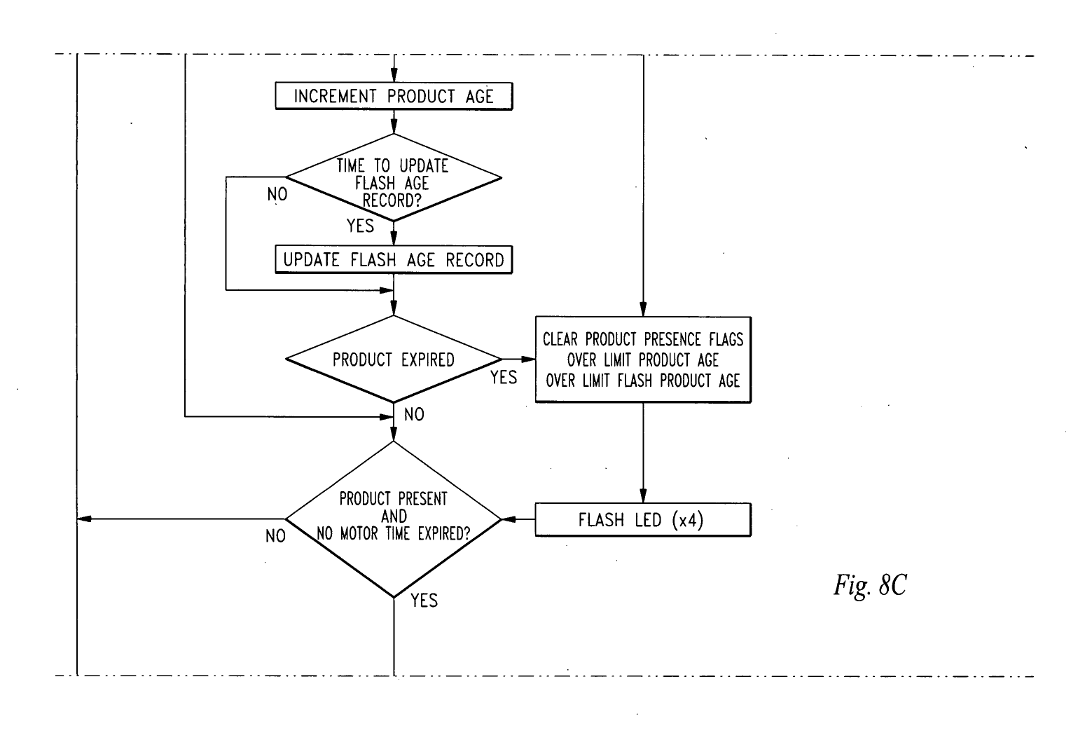

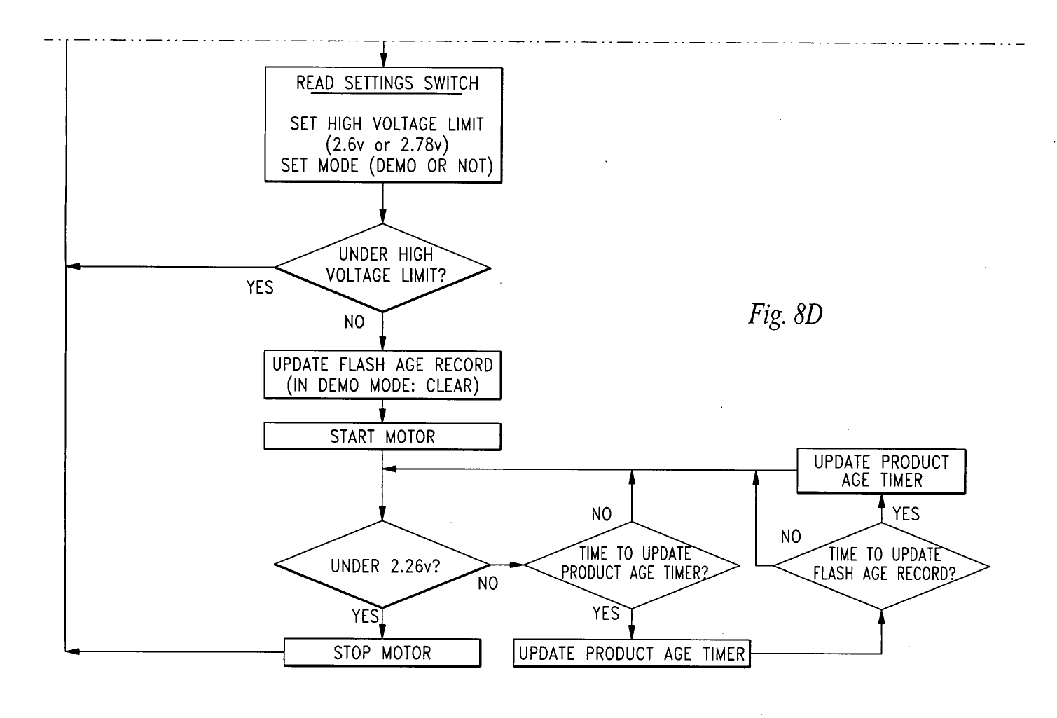

FIGS. 8 and 9 illustrate functions carried out by the circuitry of FIG. 10 in connection with structural components of the dispenser 10, for example. These include utilization of the microprocessor with embedded software to control features such as detecting the presence of proprietary products, activation duty cycles, LED's or other indicators and a slide switch to adjust activation frequencies.

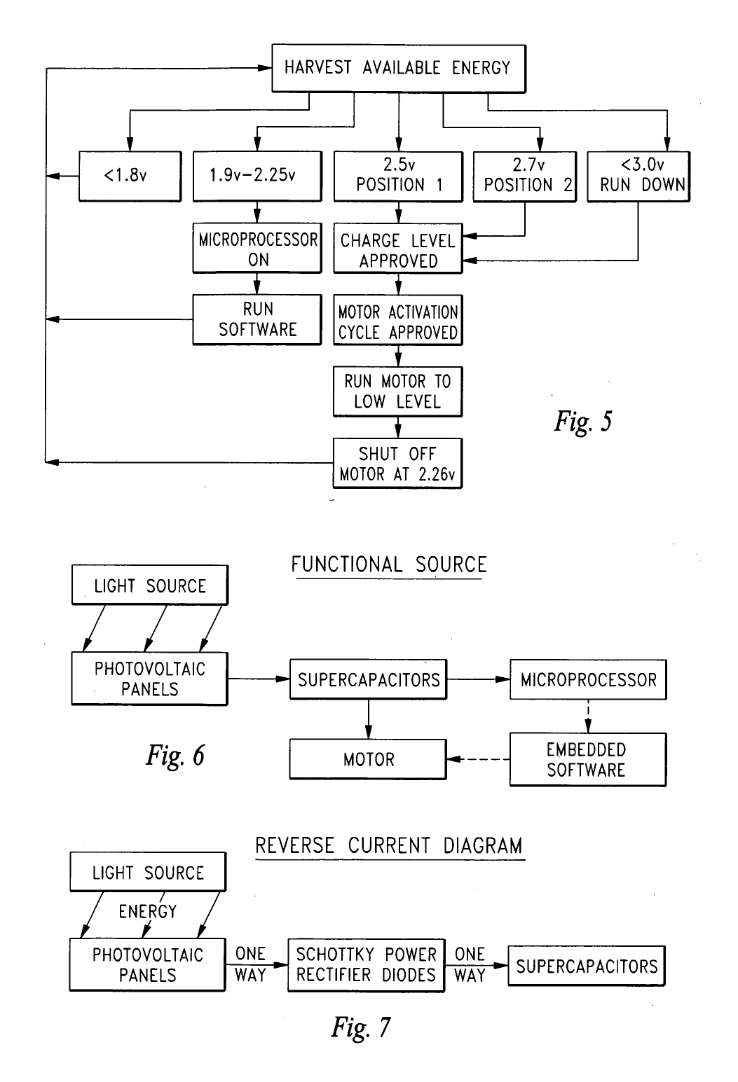

The method of the present invention is presented in FIGS. 5, 6, 7 and 8 and is practiced utilizing coded software. Two CD copies of such software are included with this application and the files specified therein attached as an Appendix.

The microprocessor is continually powered and protected by detecting and maintaining a predetermined minimum voltage level for the microprocessor. Through utilization of the charge management feature of this invention, minimum charge level will be managed and maintained in the supercapacitor or supercapacitors so as to maintain the microprocessor functionality. This is a programmable threshold.

The charge management feature is to assist in managing the stored energy in the supercapacitors by controlling the stored voltage levels. The charge management feature:

a) protects the supercapacitors from overcharging by activating functions. When the stored voltage reaches the maximum setting, the load will be activated to drain the peak charge level (this is independent of the normal duty cycle settings and supercedes all other functions), or

b) prevents the microprocessor from losing power by suspending activations. If the minimum current required for any of the activations has not been reached before an activation request, the activation request will be suspended until the appropriate voltage is achieved.

The energy harvested is managed by software that is embedded into the microprocessor and is programmable to different thresholds or requirements depending on the activation requirements. The solar panels perpetually and independently harvest energy regardless of other features or requirements. FIG. 5 may be referred to as exemplary of a microprocessor programmable to different thresholds or requirements depending on the activation requirements. In this embodiment the charge management settings include:
Low limit voltage setting
High limit voltage setting
Run down interval voltage setting
Minimum voltage protection for processor.

Sample load interval settings are:
Position 1 (cycle starts 2.5v and shuts off at 2.26v)
Position 2 (cycle starts 2.7v and shuts off at 2.26v)
Position 3 (demo mode).

Running based on voltage provides long and short run times that auto scale to the light conditions the product lives in. The end user cannot alter these settings, as they are stored values in the embedded software. They are superceded by the charge management requirements and are strictly voltage based. When the load is activated it will run until the voltage level is drained to the run down threshold of 2.26v and then shut off.

The embedded control logic functions are shown in the flow chart (firmware flow diagram) of FIG. 8.

The energy harvesting is unrelated to and independent of other operations or features. The load requirement may be filled regardless of other features in order to maintain the charge management. The energy is then stored via one or more supercapacitors and is available upon demand to power activations administered through either interval activation settings (time based) or the superseding charge management feature.

Load activations and internal times are programmable using the embedded control software and may include adjustability by the end user.

The internal clock for the microprocessor must be protected so that the timer counts can be stored within the processor's FLASH or EPROM. The clock may be updated periodically to ensure time is recalled through processor brown outs caused by a lack of harvestable light energy. This timer may be programmable and reset if needed.

An optional indicator based on a predetermined internal timer in the processor identifies additional features implemented when required. Optional indicators may include a LED or other indicators that will designate encoded functionality controlled by the microprocessor (such as a calendar expiration). Once the optional indicator based functions expire, activations may be suspended unless the charge management feature is required.

Referring now to the reverse current diagram of FIG. 7, to prevent the harvested energy from making or the reverse charging of the photovoltaic panels, Schottky power rectifier diodes are placed between the photo electric panels and the supercapacitors and act as a one-way gate. This optimizes the harvest current received and stored by the supercapacitors.

The invention claimed is:

1. Apparatus for harvesting and storing energy, said apparatus employed as an electrical power source for an electrically operated device, said apparatus comprising, in combination:
photovoltaic structure continuously harvesting energy from an internal lighting system;
at least one supercapacitor for receiving and storing electrical energy produced by said photovoltaic structure; and
a microprocessor operatively associated with said at least one supercapacitor and with said electrically operated device, said microprocessor being continually powered by said at least one supercapacitor and programmed to activate or allow activation of said electrically operated device only when the stored energy in said at least one supercapicitor exceeds a minimum voltage charge level sufficient to maintain operation of said microprocessor.

2. The apparatus according to claim 1 wherein said microprocessor is cooperable with said at least one supercapacitor to manage the level and usage of stored energy in said at least one supercapacitor.

3. The apparatus according to claim 2 wherein said microprocessor is incorporated in electrical circuitry operatively associated with said at least one supercapacitor, said electrical circuitry including a sensor for sensing the voltage charge level of said at least one supercapacitor, said electrical circuitry additionally being in operative association with said electrically operated device to actuate the electrically operated device or another electrically operated device or load to drain the voltage charge level of said at least one supercapacitor to prevent overcharging of said at least one supercapacitor.

4. The apparatus according to claim 2 wherein said supercapacitor is incorporated in electrical circuitry operatively associated with said at least one supercapacitor and with said electrically operated device, said electrical circuitry utilized to activate said electrically operated device, and said microprocessor programmed to temporarily suspend activation of said electrically operated device until the minimum current required for such activation has been reached.

5. The apparatus according to claim 1 wherein said photovoltaic structure comprises at least one indoor solar panel.

6. The apparatus according to claim 1 wherein said electrically operated device is a motor.

7. The apparatus according to claim 1 additionally including protection structure operatively associated with said photovoltaic structure and said at least one supercapacitor acting as a one way gate optimizing charging of said at least one supercapacitor by said photovoltaic structure and preventing reverse current flow from said at least one supercapacitor back to said photovoltaic structure.

8. The apparatus according to claim 7 wherein said protection structure comprises Schottky power rectifier diodes.

9. The apparatus according to claim 1 employed as an electrical power source for a plurality of electrically operated devices and wherein said microprocessor is operatively associated with each of said plurality of electrically operated devices.

10. The apparatus according to claim 9 wherein control software is embedded in said microprocessor for individually controlling activations of said plurality of electrically operated devices.

11. The apparatus according to claim 1 wherein said apparatus is employed as the sole electrical power source for said at least one electrically operated device.

12. The apparatus according to claim 10 wherein the control software embedded in said microprocessor enables time based or manual activations of one or more of said plurality of electrically operated devices subject to the voltage charge level in said at least one supercapacitor exceeding the voltage charge level required to operate said microprocessor to enable said activations.

13. The apparatus according to claim 12 wherein said plurality of electrically operated devices are incorporated in a dispenser for dispensing a scent or air freshener and include a motor periodically actuatable to dispense the scent or air freshener.

14. The apparatus according to claim 13 wherein said plurality of electrically operated devices include a detector for detecting the presence of a container or other holder holding a scent or air freshener to be dispensed.

15. The apparatus according to claim 13 wherein said motor is connected to a fan.

16. The apparatus according to claim 13 wherein said plurality of electrically operated devices include one or more indicator lights.

17. Apparatus for harvesting and storing energy, said apparatus comprising, in combination:
photovoltaic structure continuously harvesting energy from an internal lighting system;
at least one supercapacitor for receiving and storing electrical energy produced by said photovoltaic structure; and
a microprocessor operatively associated with said at least one supercapacitor and with said electrically operated device, said microprocessor being continually powered by said at least one supercapacitor and programmed to manage the voltage charge level of said at least one supercapacitor so that it has or exceeds a minimum voltage charge level sufficient to operate said microprocessor and does not exceed a predetermined maximum voltage charge level.

18. A method of harvesting and storing energy employed to power an electrically operated device, said method including the steps of:
continuously harvesting energy from an internal lighting system utilizing a photovoltaic structure;
employing at least one supercapacitor to receive and store electrical energy produced by said photovoltaic structure;
placing a microprocessor in operative association with said at least one supercapacitor and with said electrically operated device;
utilizing said at least one supercapacitor to continually power said microprocessor; and
employing said microprocessor to activate or allow activation of said electrically operated device from the stored energy in said at least one supercapacitor only when the stored energy exceeds a minimum voltage charge level sufficient to maintain operation of said microprocessor.

19. The method according to claim 18 wherein said microprocessor is cooperable with said at least one supercapacitor to manage the level and usage of stored energy in said at least one supercapacitor.

20. The method according to claim 19 wherein said microprocessor is incorporated in electrical circuitry operatively associated with said at least one supercapacitor and said electrically operated device, and including the steps of employing a sensor in said electrical circuitry to sense the voltage charge level of said at least one supercapacitor and utilizing said electrical circuitry to actuate the electrically operated device or another electrically operated device or load to drain the voltage charge level of said at least one supercapacitor to prevent overcharging of said at least one supercapacitor.

21. The method according to claim 20 wherein said supercapacitor is incorporated in electrical circuitry operatively associated with said at least one supercapacitor and with said electrically operated device, and including the steps of utilizing said electrical circuitry to activate said electrically operated device, and employing said microprocessor to temporarily suspend activation of said electrically operated device until the minimum current required for such activation has been reached.

22. The method according to claim 18 wherein said photovoltaic structure comprises at least one indoor solar panel.

23. The method according to claim 18 wherein said electrically operated device is a motor.

24. The method according to claim 18 additionally including placing protection structure in operative association with said photovoltaic structure and said at least one supercapacitor which acts as a one way gate optimizing charging of said at least one supercapacitor by said photovoltaic structure and preventing reverse current flow from said at least one supercapacitor back to said photovoltaic structure.

25. The method according to claim 24 wherein Schottky power rectifier diodes are employed as said protection structure.

26. The method according to claim 18 employed to power plurality of electrically operated devices and wherein said microprocessor is operatively associated with each of said plurality of electrically operated devices.

27. The method according to claim 26 wherein control software is embedded in said microprocessor for individually controlling activations of said plurality of electrically operated devices.

28. The method according to claim 18 employed to provide the sole electrical power source for said at least one electrically operated device.

29. The method according to claim 27 including the step of utilizing the control software embedded in said microprocessor to enable time based or manual activations of one or more of said plurality of electrically operated devices subject to the voltage charge level in said at least one supercapacitor exceeding the voltage charge level required to operate said microprocessor to enable said activations.

30. The method according to claim 29 wherein said plurality of electrically operated devices are incorporated in a dispenser for dispensing a scent or air freshener and include a motor periodically actuatable to dispense the scent or air freshener.

31. The method according to claim 30 wherein said plurality of electrically operated devices include a detector for detecting the presence of a container or other holder holding a scent or air freshener to be dispensed.

32. The method according to claim 30 wherein said motor is connected to a fan.

33. The method according to claim 30 wherein said plurality of electrically operated devices include one or more indicator lights.

34. A method of harvesting and storing energy employed to power an electrically operated device, said method including the steps of:
continuously harvesting energy from an internal lighting system utilizing a photovoltaic structure;
employing at least one supercapacitor to receive and store electrical energy produced by said photovoltaic structure;
placing a microprocessor in operative association with said at least one supercapacitor and with said electrically operated device;
utilizing said at least one supercapacitor to continually power said microprocessor; and
employing said microprocessor to manage the voltage charge level of said at least one supercapacitor so that it has or exceeds a minimum voltage charge level sufficient to operate said microprocessor and does not exceed a predetermined maximum voltage charge level.
